(19) United States
(12) Patent Application Publication
(10) Pub. No.: US 2023/0292800 A1
(43) Pub. Date: Sep. 21, 2023

(54) PROCEDURES FOR OBTAINING CALCIUM OXIDE FROM EGGSHELLS WITH APPLICATIONS IN FOOD PROCESSING

(71) Applicant: XAM, SOCIEDAD ANONIMA, Guatemala (GT)

(72) Inventors: NINA IBARGUEN PONCE, Guatemala (GT); MARIA JOSE SANCHEZ ROSENBERG, Guatemala (GT)

(21) Appl. No.: 18/122,243

(22) Filed: Mar. 16, 2023

(30) Foreign Application Priority Data
Mar. 18, 2022 (GT) A2022-000060

(51) Int. Cl. A23L 15/00; C01F 11/06; C04B 2/04; A23L 7/10

(52) U.S. Cl. CPC A23L 15/00; C01F 11/06; C04B 2/04; A23L 7/101; A23L 7/197

(57) ABSTRACT

The procedures for obtaining calcium oxide from eggshells with applications in food processes, refers to the plurality of procedures for obtaining Calcium Oxide (XAM), from eggshells, is based on a circular economy, in which waste eggshells are collected from different food establishments and agglomerated in the production center. The application of high temperatures (>900° C.) to the crushed eggshells, provides the transformation of calcium carbonate (CaCO3) into calcium oxide (CaO) with a pH that exceeds 12. The use of XAM as a raw material with the aforementioned characteristics, constitutes the ideal component to alkalinize different preparations in the production of different foods and particularly in the nixtamalization procedures for the production of corn dough prior to the production of tortillas, tamales, and other varieties of food.

### INTRODUCTION

Historically in any country in the world, the consumption of poultry eggs has constituted a fundamental source of food in all families. For a very long time, in many places, it has been customary to use eggshells as a source of calcium (calcium carbonate) in different processes and for many purposes; which range from medicinal through agricultural to food which is the subject that currently concerns us. On the other hand, the process or processes used in the present innovation lead to the improvement in the quality of the target products with the application and/or substitution of elements in the nixtamalization processes and the respective use everywhere, facilitating and improving the nutritional levels for the products of daily consumption in the feeding of the population that likes the benefits and flavors of corn in its different presentations.

When analyzing eggshells, which constitute the external hard part of every poultry egg, it is assumed that they constitute a conglomerate of protein aligned with mineral crystals, mostly calcium in mineral compounds such as Calcium Carbonate (94% approximately), Sodium, Magnesium, Phosphorus, Zinc, Manganese, Iron, Copper, Aluminum, Selenium, Strontium and Boron. Eggshells make up between 10 and 15% of the weight of eggs. The membrane is also a source of Collagen and Hyaluronic Acid.

The present invention comes as an answer to a question we asked ourselves, how can we take 100% advantage of such a complete food as the egg? And the answer was not easy, but after a lot of hard work, we came to the conception of a product made from food waste from different restaurants and companies in the food industry; specifically, from eggshells. Using a circular economy model, the waste is collected and then processed to obtain a raw material equivalent in its physicochemical properties to lime. This raw material is called Xam, which means “fire” in the Mayan Kekchi language, and represents the center of gastronomic processes. Xam can be used as a substitute for lime in the nixtamalization process, as well as in other alkalinization processes.

### DESCRIPTION

The procedure for obtaining XAM (calcium oxide) from eggshells is based on a circular economy, where waste eggshells are collected from different food establishments and agglomerated in the production center. The application of high temperatures (>900° C.) to the crushed eggshells, provides the transformation of calcium carbonate (CaCO3) into calcium oxide (CaO) with a pH that exceeds 12, which is important for the process of corn nixtamalization and its processes for the production of tortillas, tamales and other products with nixtamalized corn dough; important and infallible foods in the food and diet of most of the population in general and mainly in Latin America.

Currently and following the ancestral customs regarding the use of quicklime in the processes of nixtamalization, a trend or custom that is deeply rooted in the eating habits of most of the population of Mesoamerica, but due to many phenomena, especially the migratory phenomena and its constant increase to the northern countries; in said countries it has become necessary to produce products that involve the above-mentioned processes of nixtamalization.

Therefore, it is necessary to upgrade the procedures and components to improve the nutritional content, as well as to make them more efficient and friendly to the environment and the population in general in order to continue tasting the usual and delicious tortillas with the usual freshness due to the way of preparation and presentation, as well as the different varieties present in the diet and nutrition of the entire corn flour consuming population.

The use of XAM as a raw material with the aforementioned characteristics constitutes the ideal component to alkalinize different preparations in the production of different foods and particularly in the nixtamalization procedures for the production of corn dough prior to the production of tortillas, tamales, and other varieties of food; thus, the technique of using eggshells to take advantage of their high calcium content and the calcination process at temperatures higher than 900° C., transforming them into calcium oxide with an alkalinity higher than 12, thus creating the ideal conditions to use this raw material in the processes of nixtamalization, hot or cold maceration; this technique is a solid-liquid extraction process, the solid product has a series of soluble compounds in the extracting liquid during a determined period of time.

The most popular liquid for maceration is water, but alcohols, oils, wines, vinegars and even syrups can also be used. Thus, obtaining calcium oxide by calcination of eggshells (calcium carbonate) and its application to specific processes of the food industry, specifically with the processes of obtaining nixtamalization, production of corn dough and other food processes, which is even reinforced with other mineral ingredients and chemical elements that strengthen the products or processes made under these techniques, procedures and raw materials, giving an added value to the improvement in food and nutrition of the population in general.

### DETAILED DESCRIPTION

A) Obtaining Calcium Oxide from Eggshell.

Taking into account the fact that eggshell contains 94% of calcium carbonate and using the pyrolysis reaction of calcium carbonate, the eggshell must be subjected to a temperature that exceeds the decomposition temperature of calcium carbonate (between 800° C.-1,500° C.).

The procedure is as follows:
1. Collect previously used eggshells (i.e., they should not contain egg inside; but it does not matter if they have egg residues).
2. When eggshells are collected, they are crushed in such a way that they can be stacked on top of each other, making sure that the quantity is not too large so that the calcination process is uniform. (This is in order to be able to take advantage of all the space in the oven; the shells do not have to keep their shape).
3. Place eggshells inside the oven used.
4. Raise the temperature until it reaches a range between 800° C. to 1,500° C. and let the shell remain in this temperature range for 30 minutes to 6 hours.
5. At the end of the time range, let the product cool inside the oven until it is manageable for a range of 1 hour to 5 hours.
6. After cooling, the calcined shells are transferred to a crushing facilitator where they are ground to the desired particle size (100% of the product passes through the sieve).

### B) Calcium Hydroxide Solution

Using water, a calcium hydroxide solution must be made, using the product of the previous incineration (product=Xam). The objective is to have a solution with a high alkalinity between pH 9 to 15. This will be used for further treatment of different ingredients. The procedure is as follows:
1. In a pot or deep dish, place a quantity of water between 500 milliliters up to 10 liters.
2. To this, add an amount of Xam (previously calcined eggshell) between 5 grams to 100 grams. It should be stirred well.
3. The alkalinity of this solution should be in a pH range between 9 to 15.
4. Once this solution is ready, it can be used in food in two main ways, cold or hot maceration. This can be done with any food.

### C) Hot Maceration

The previously prepared solution can be used to subject different animal proteins, vegetables, cereals, fruits and/or vegetables to an alkaline heat maceration. The objective of this maceration is to alter the external and/or internal texture of the food. The food can be subjected to an alkaline maceration in heat for a time between 15 minutes to 10 hours, depending on the final result to be obtained and taking into account the hardness of the food.

The procedure is as follows:
1. Place the alkaline solution in a deep, heat-resistant container (pot or pan) that can hold the desired food.
2. Immerse the food, with or without skin, making sure that it is completely covered with the alkaline solution.
3. Raise the heat to a range that may include: low, medium-low, medium, medium-high, and high.
4. Leave the food inside the solution subjected to heat for 15 minutes to 10 hours; depending on the thickness of the Calcium Pectate film to be created and also on the hardness of the food.
5. At the end of the heat maceration time, the food should be left soaking in the solution, with the fire turned off, for a period of 10 minutes to 24 hours.
6. At the end of the soaking period, the food is removed from the solution and washed thoroughly with water to remove any Xam residue, if necessary, washing it several times.
7. Place the macerated food in a container and reserve it according to its biochemical needs.

### D) Cold Maceration

The previously prepared solution can be used to subject different animal proteins, vegetable proteins, cereals, fruits and/or vegetables to an alkaline cold maceration. The objective of this maceration is to alter the external and/or internal texture of the food. The food can be subjected to an alkaline cold maceration for a time between 15 minutes to 10 hours. The procedure is as follows:
1. Place the alkaline solution in a deep container that can hold the desired food.
2. Immerse the food, with or without skin, making sure that it is completely covered with the alkaline solution.
3. Keep in a cool place, either refrigerated or at room temperature (depending on the type of food and its handling), for the necessary time between 15 minutes and 10 hours.
4. Remove the food from the solution once the desired film has been achieved.
5. Thoroughly wash the food with water to remove any evident residual Xam, if necessary, wash several times.
6. Place the macerated food in a container and reserve it according to its biochemical needs.

### BACKGROUND OF THE INVENTION

### Field of the Invention

This invention relates to a series of processes for obtaining calcium oxide from poultry eggshells with diverse applications in the food industry.

### Description of the Prior Art

Various techniques have heretofore been provided for obtaining Calcium Oxide from poultry eggshells.

In a system described in China patent CN 107,963,647 of Yi Pin International Biotechnology CO., LTD. said invention provides a method for preparing calcium oxide. Said method comprises the following steps:

Cleaning eggshells by using ultrasonic waves in the presence of a detergent in a drying chamber from three stages wherein the third stage comprises calcination and adding a detergent and a mixture of calcium ion powder, natural sea salt, sodium percarbonate and sodium citrate.

Furthermore, in JP 2008008600 Apln. From Kansei Kigyo K K. In the public disclosure of a Continuous heat treatment device and continuous calcining device for eggshell or seashells, it refers to an external calcining kiln that does not use direct heating by a burner.

However, in Korean publication KR 20150028061, by HYUN KYOUNG TAE. Method for producing calcined calcium and water-soluble eggshell calcium using eggshell as the main ingredient, with the difference that the calcined calcium powder is mixed with vinegar containing acetic acid to become water-soluble ionic calcium.

Also in patent U.S. Pat. No. 11,001,700 Tyson Foods, Inc. presents a process for manufacturing eggshell powder for use in the production of bio-based products. The process involves exposing eggshells to high velocity air at room temperature to pulverize the eggshell and separate the shells from the internal membrane component.

### DRAWINGS

### BRIEF DESCRIPTION OF THE DRAWING

Calcium Oxide manufacturing process flow diagram and uses in the food industry.

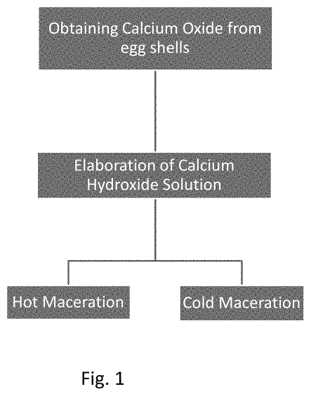

FIG. 1: A Flow Diagram for making Calcium Oxide from eggshells is appreciated and schematically shows the food processes for developing Calcium Hydroxide and its possible uses as raw materials in the food industry.

1. A method for obtaining calcium oxide from eggshells with applications in food processes, comprising the steps of:
a) Collecting previously used eggshells, without egg residues inside; but it does not matter if they do;
b) When collecting the eggshells, they are crushed in such a way that they can be piled up one on top of the other, trying not to have a very large quantity so that the calcination process is uniform to take advantage of all the space of the oven; the shells do not have to maintain their form;
c) To place eggshells inside the oven used;
d) Raise the temperature until it reaches a range between 800° C. to 1,500° C. and let the shell remain in this temperature range between 30 minutes and 6 hours;
e) At the end of the time range, the product is allowed to cool inside the oven until it is manageable for a range of 1 hour to 5 hours; and
f) After cooling, the calcined shells are transferred to a crushing facilitator where they are ground to the desired particle size.

2. The method for obtaining calcium oxide from eggshells with applications in food processes, according to claim No. 1, comprising the following steps:
a) Using water, a calcium hydroxide solution is to be made, using the product of previous incineration to have a solution with a high alkalinity, with a pH of 9 to 15;
b) In a container, place a quantity of water between 500 milliliters up to 10 liters and add a quantity of previously calcined eggshell (XAM), between 5 grams to 100 grams;
c) The previous solution must be well homogeneous and totally mixed; and
d) Once this solution is ready, it can be used in a great variety of foods in two main ways: cold or hot maceration.

3. The method for obtaining calcium oxide from eggshells with applications in food processes, according to claim 1 wherein it can comprise:
maceration in heat: the previously prepared solution can be used to subject different animal proteins, vegetables, cereals, fruits and/or vegetables to an alkaline maceration in heat, the purpose of this maceration is to alter the external and/or internal texture of the food and food can be subjected to an alkaline maceration in heat for a time between 15 minutes to 10 hours, depending on the final result to be obtained and taking into account the hardness of the food comprising the steps of:
a) Place the alkaline solution in a deep, heat-resistant container that can hold the desired food;
b) Immerse the food, with or without shell, making sure that it is completely covered with the alkaline solution;
c) Raise the heat to a range that may include: low, medium-low, medium, medium-high, and high;
d) Leave the food inside the solution subjected to heat for 15 minutes to 10 hours; depending on the thickness of the Calcium Pectate film to be created and also on the hardness of the food;
e) At the end of the heat maceration time, the food should be left soaking in the solution, with the fire off, for a period of 10 minutes to 24 hours;
f) At the end of the maceration period, remove the food from the solution and wash it deeply with water to remove any residue of Xam, if necessary wash it several times; and
g) Place the macerated food in a container and reserve it according to its biochemical needs.

4. The method for obtaining calcium oxide from eggshells with applications in food processes, according to claim 1 wherein it may comprise
cold maceration: the previously prepared solution can be used to subject different animal proteins, vegetable proteins, cereals, fruits and/or vegetables to a cold alkaline maceration, the purpose of this maceration is to alter the external and/or internal texture of the food and the food can be subjected to an alkaline cold maceration for a time between 15 minutes to 10 hours comprising the steps of:
a) Place the alkaline solution in a deep container that can hold the desired food;
b) Immerse the food, with or without shell, making sure that it is completely covered with the alkaline solution;
c) Keep in a cool place, either refrigerated or at room temperature (depending on the type of food and its handling), for the necessary time between 15 minutes and 10 hours;
d) Remove the food from the solution once the desired film has been achieved;
e) Thoroughly wash the food with water to remove any evident residual Xam, if necessary, wash several times and
f) Place the macerated food in a container and reserve it according to its biochemical needs.
